(19) United States
(12) Patent Application Publication
(10) Pub. No.: US 2025/0214282 A1
(43) Pub. Date: Jul. 3, 2025

(54) METHOD FOR PROCESSING DAIRY BOTTLE RECYCLATE IN A NEW PRODUCTION OF DAIRY BOTTLES (CLOSED-LOOP, BOTTLE-TO-BOTTLE) AND PRODUCT OBTAINED FROM IT

(71) Applicant: RESILUX N.V., Wetteren (BE)

(72) Inventors: Pieterjan LENAIN, Wetteren (BE); Tom ANTHIERENS, Wetteren (BE); Dirk DE CUYPER, Wetteren (BE)

(21) Appl. No.: 18/835,071

(22) PCT Filed: Feb. 3, 2023
(86) PCT No.: PCT/IB2023/050978

§ 371 Date: Aug. 1, 2024

(30) Foreign Application Priority Data
Feb. 3, 2022 (BE) 2022/5068

(51) Int. Cl. B29B 17/04; B29C 49/00; B29C 49/06; B29C 49/22; B29K 67/00; B29L 31/00; B32B 7/02; B32B 27/08; B32B 27/36; B65D 1/02

(52) U.S. Cl. CPC B29B 17/0412; B29C 49/0005; B29C 49/06; B29C 49/22; B32B 7/02; B32B 27/08; B32B 27/36; B65D 1/0215; B29K 2067/003; B29K 2995/0025; B29L 2031/7158; B32B 2250/03; B32B 2272/00; B32B 2307/4026; B32B 2307/41; B32B 2307/7376; B32B 2439/60; B32B 2439/70

(57) ABSTRACT

The present invention provides a method for processing dairy bottle recyclate in a new production of dairy bottles (closed-loop; bottle-to-bottle). The invention also provides a multilayer plastic bottle for containing and storing dairy products, obtainable by a method according to the invention.

### TECHNOLOGY DOMAIN

The invention is situated in the domain of waste treatment and recycling, more specifically the reuse of product streams obtained from processing plastic packaging, more specifically dairy bottles. The invention is also situated in the domain of plastic preforms and bottles obtained from plastic preforms; in particular plastic dairy bottles.

### BACKGROUND

Plastic packaging are widely known and widespread. In the state of the art, many types of plastic bottles are known, including so-called polypropylene, polycarbonate, polyethylene and polyester bottles. These bottles are used for a variety of applications and are amongst other things appropriate for containing beverages, including dairy products.

Beverage containers are usually transparent. This includes beverage bottles for water, soft drinks, alcoholic beverages. Transparent beverage containers, especially PET packagings, recycle well. The material stream obtained from the processing of empty PET beverage containers can be reused to make new beverage bottles.

Beverage bottles for which no reuse is possible so far, are milk bottles. Polyolefin milk bottles coloured white are commonly known. PET-based, white-coloured milk bottles with a carbon black-based light barrier are becoming increasingly common. The processing of these milk bottles is problematic. When shredding the bottles, a stream of PET chips of grey colour is created. These is no sales market for this food-contact material. The material is considered waste and is incinerated. The use of these plastic milk bottles is discouraged by environmental taxes.

Plastic packaging for non-beverage applications is also often opaque. Examples include plastic bottles for detergents, sauces, oil. The opaque property is obtained through the use of dyes and additives. A ketchup bottle, for example, is often coloured red. PET is also being used more and more here. For the coloured waste stream (red, green, blue, yellow, other colours), there is hardly any sales market. “Non-coloured” colours are white, grey and black.

An additional problem is the standardisation for beverage bottles. The Food Contact regulations stipulate that at most 5% by weight of a food or beverage packaging is derived from something that was not so-called Food Contact Approved. Today, it is very difficult for a bottle producer to control the use and content of non-food recyclate.

The invention seeks to provide a solution to at least one of the problems described above. In particular, the invention seeks to provide a solution for the sustainable use of polyester, preferably PET, in plastic packaging, in particular in beverage packaging and especially in milk bottles.

### SUMMARY OF THE INVENTION

In a first aspect, the invention provides a method for processing dairy bottle recyclate into a new production of dairy bottles, comprising the steps:
shredding used plastic dairy bottles, followed by mechanical recycling, in which a dairy bottle recyclate in the form of a granulate is obtained,
incorporating the dairy bottle recyclate by injection moulding thereby forming a middle layer in a preform for a new multilayer plastic dairy bottle, the preform after incorporation comprising an inner layer for contact with the contents of the dairy bottle in use, an outer layer located opposite the inner layer and a middle layer located between the inner and outer layer;
in which the inner and outer layers are white and the middle layer is black, grey or coloured; and
in which the middle layer has less than 5% transmission of light measured by a spectrophotometer according to ASTM D1003 at 530 nm, using a D65 lamp simulating natural daylight.

In a further aspect, the invention relates to a multilayer plastic bottle for containing and storing dairy products, comprising an inner layer for contact with the contents of the bottle or preform, an outer layer located opposite the inner layer and a middle layer located between the outer and the inner layer, characterized in that the middle layer comprises an opaque plastic fraction, the middle layer is black, grey or coloured, and wherein the multilayer dairy plastic bottle can be obtained with a method according to an embodiment of the invention; and wherein the middle layer has less than 5% transmission of light measured by a spectrophotometer according to ASTM D1003 at 530 nm, using a D65 lamp simulating natural daylight.

The term “opaque” or “opacity” as used herein, refers to the measure of light impermeability of a material. Opacity is expressed as a ratio of transmitted light flux to incident light flux. The opposite of opacity is transmittance or transmission. Opacity and opaque refer to a non-transparent material. A transparent or slightly translucent plastic container can be made opaque by adding fillers and/or pigments.

Less than 20% of transmission is considered as opaque, while more than 20% of transmission corresponds to a transparent or translucent material. Opaque bottles are especially used for milk bottles and detergent bottles. For dairy bottles, it is important to provide sufficient opacity for preserving vitamins in dairy products.

The use of an opaque plastic fraction in the middle layer, and preferably an opaque middle layer, has the advantage that the middle layer contributes to making a bottle impermeable to light.

In a third aspect, the invention provides a multilayer dairy packaging, comprising a multilayer plastic bottle according to a preferred embodiment of the invention and a sterilized dairy product contained in the multilayer plastic bottle; preferably, the sterilized dairy product is milk.

### DETAILED DESCRIPTION OF THE INVENTION

Unless otherwise specified, all terms used in the description of the invention, including technical and scientific terms, shall have the meaning as they are generally understood by the worker in the technical field the present invention relates to. Furthermore, definitions of the terms have been included for a better understanding of the description of the present invention.

As used here, the following terms shall have the following meaning: “A”, “an” and “the”, as used here, refer to both the singular and the plural form unless clearly understood differently in the context. For example, “a compartment” refers to one or more than one compartment.

“Approximately” as used here, that refers to a measurable value such as a parameter, a quantity, a period, etc., is meant to include variations of +/−20% or less, preferably +/−10% or less, more preferably +/−5% or less, still more preferably +/−1% or less, and even still more preferably +/−0.1% or less of the cited value, as far as such variations are appropriate for realizing the invention that is described. It will however be clear that the value to which the term “approximately” relates, will also be described specifically. The terms “include”, “including” and “included”, as used here, are synonym with “comprise”, “comprising” and “comprises” and are inclusive of open terms that indicate the presence of what follows e.g. a component, and that do not exclude the presence of additional, non-said components, characteristics, elements, members, steps, that are well-known from or described in the state of the art.

The citation of numeric intervals by means of end points includes all integers and fractions included within that interval, including these end points.

The term “% by weight” as used here, refers to a weight percentage in which the ratio of the weight of an ingredient to the total weight of a bottle without a closing means, is expressed as a percentage.

In a first aspect, the invention provides a method for processing dairy bottle recyclate into a new production of dairy bottles, comprising the steps:
shredding used plastic dairy bottles, followed by mechanical recycling, in which a dairy bottle recyclate in the form of a granulate is obtained,
incorporating the dairy bottle recyclate by injection moulding thereby forming a middle layer in a preform for a new multilayer plastic dairy bottle, the preform after incorporation comprising an inner layer for contact with the contents of the dairy bottle in use, an outer layer located opposite the inner layer and a middle layer located between the inner and outer layer;
in which the inner and outer layers are white and the middle layer is black, grey or coloured; and
in which the middle layer has less than 5% transmission of light measured by a spectrophotometer according to ASTM D1003 at 530 nm, using a D65 lamp simulating natural daylight.

The very limited light transmission provided by the middle layer is advantageous for reducing the degradation of vitamin B2 in dairy products. 530 nm is the UV-visible light absorption maximum for riboflavin (vitamin B2). Riboflavin is mainly found in dairy products such as milk.

Shredding plastic dairy bottles can be obtained by cutting or grinding.

The term “granulate” refers to a solid material in a granular form.

Preferably, the dairy bottle recyclate is coloured. Coloured means having a colour, and thus not being black, white or grey.

Preferably, the middle layer comprises an opaque coloured plastic fraction, more preferably an opaque coloured polyester fraction.

Even more preferably, the middle layer comprises an opaque green polyester fraction. Opaque green plastic fractions currently have very little reuse. The use of these materials has a beneficial environmental impact. Incineration as a solution for processing an opaque green polyester fraction can be reduced and possibly even avoided.

Preferably, the middle layer has a light transmission of less than 1%, more preferably less than 0.5%, most preferably less than 0.1%. This has the advantage that the middle layer provides a light barrier for the preservation of vitamin B2 in dairy products. These products are typically stored in plastic dairy bottles.

Preferably, up to 5% of non-food recyclate is processed in the dairy bottle. More preferably up to 3%, even more preferably up to 1%, most preferably 0% of non-food recyclate is processed in the dairy bottle.

In a method according to a preferred embodiment of the invention, the dairy bottle recyclate is a milk bottle recyclate. Also, the new dairy bottles are preferably milk bottles.

The dairy bottle recyclate is preferably a polyester plastic fraction. More preferably, the dairy bottle recyclate is a PET fraction.

The plastic preform is preferably obtained by injection moulding.

The multilayer structure of the preform is preferably obtained by co-injection. The simultaneous use of different raw materials is advantageous for time utilization in a production process. A preform obtained from a co-injection process has improved layer adhesion.

In a method according to a preferred embodiment of the invention, the method also comprises the following steps:
producing a preform in an injection mould, wherein a predetermined amount of a first material is injected into a mould cavity and a predetermined amount of a second material is injected into this mould cavity to form a core in the injected first material,
wherein, in a main phase, the first material is completely injected into the mould cavity, followed by the second material which is completely injected, in a consecutive injection,
wherein, during the consecutive injection, the first material is injected to provide an inner and an outer side of a preform and the second material is injected into an area at the level of the injection opening of the injection mould to provide a middle layer of a preform located between the inner and outer side of the preform,
in a final phase, the first material will be pushed to the preform mouth by injecting the second material, the second material always being injected into the middle layer without the possibility of breaking through to the inner of outer side of the preform,
characterised in that,
the first material is polyester, and the second material is an opaque plastic fraction to the exclusion of a black opaque plastic fraction; preferably, the second material is an opaque coloured polyester plastic fraction.

In an alternative method according to a preferred embodiment of the invention, the method also comprises the following steps:
producing a preform in an injection mould, wherein a predetermined amount of a first material is injected into a mould cavity and a predetermined amount of a second material is injected into this mould cavity to form a core in the injected first material,
wherein, during parallel injection, the first material is injected on the inner and outer side and the second material is injected in the middle layer in an area at the level of the injection opening of the injection mould
wherein, in a preliminary phase, only a predetermined amount of the first material is injected into the injection mould.
wherein, in a final phase, a predetermined amount of the first material is injected, and, as appropriate, the second material is further pushed into a front portion of the injection mould, characterised in that,
the first material is polyester and the second material is an opaque plastic fraction to the exclusion of a black opaque plastic fraction; preferably, the second material is an opaque coloured polyester plastic fraction.

In a method according to a preferred embodiment of the invention, the preforms are blown thereby forming the new dairy bottles comprising, in the middle layer, dairy bottle recyclate.

The multilayer plastic bottle is preferably obtained by co-injection blow moulding. In a co-injection blow moulding process, a co-injection moulding process for the production of a preform is followed by blowing the preform into a bottle shape.

Preferably, the material in the middle layer is additionally coloured to increase the opacity of the middle layer.

Preferably, the middle layer provides at least 5% of wall thickness. Wall thickness can be measured using techniques which are well-known to the skilled worker.

In the middle layer, a recycled opaque plastic fraction obtained from the processing of used plastic bottles or plastic preforms for dairy bottles is incorporated. In this way, dairy bottle materials are reused for producing dairy bottles. This co-called closed-loop system, or bottle-to-bottle recycling system, is part of the present invention. The dairy bottles obtained in this way are durable and reusable.

In a method according to a preferred embodiment of the invention, the dairy bottles from a dairy bottle filler are reworked into new dairy bottles for the same filler. This method provides bottles that are reworked into new bottles comprising bottle recyclate; the so-called “bottle-to-bottle” principle.

In a method according to a preferred embodiment of the invention, the used dairy bottles from a pre-identified dairy bottle filler are collected separately and processed into new dairy bottles for the pre-identified dairy bottle filler. This method provides material control; the so-called “closed-loop” principle.

Preferably, the middle layer provides at least 5% of wall thickness in the multilayer preform or plastic bottle. Still more preferably, the middle layer provides at least 20%, at least 25%, at least 30%, at least 35%, at least 40%, at least 45%, at least 50% of wall thickness. Preferably, the entire middle layer is opaque.

Said recyclate is preferably PET recyclate, more preferably opaque PET recyclate, most preferably opaque green PET recyclate. This has the advantage of increasing the reuse of PET materials, and especially opaque PET materials, which are limited in recycling applications because of their visual aspect. As an additional benefit, environmental taxes on the opaque fraction can be reduced by repurposing it.

Preferably, the outer bottle wall forms a light barrier. The multilayer plastic bottle or preform preferably has a white outer layer. Combined with the middle layer with opaque plastic fraction, less dye can be used in the outer layer. The use of new materials is reduced.

The multilayer dairy plastic bottle is preferably a bottle for containing sterilized milk, milk beverages, sterilized yogurt (beverages), cream, coffee milk).

In a further aspect, the invention relates to a multilayer plastic bottle for containing and storing dairy products, comprising an inner layer for contact with the contents of the bottle or preform, an outer layer located opposite the inner layer and a middle layer located between the outer and the inner layer, characterized in that the middle layer comprises an opaque plastic fraction, with the exclusion of a black and grey middle layer and wherein the multilayer plastic bottle is obtainable with a method according to an embodiment of the invention.

Preferably, the middle layer in the multilayer plastic bottle provides at least 5 or at least 10% of wall thickness; more preferably at least 15% of wall thickness; still more preferably at least 20% of wall thickness; most preferably at least 25% of wall thickness.

Preferably, the outer and middle layers in the multilayer plastic bottle are white.

Preferably, the middle layer comprises PET recyclate.

A multilayer plastic bottle or preform according to an embodiment of the invention preferably has a middle layer comprising at least 10% by weight of recyclate. More preferably, the middle layer comprises at least 15, 20, 25, 30, 35, 40, 45, 50% by weight of recyclate. Still more preferably, the middle layer includes at least 55, 60, 65, 70, 75, 80, 85, 90% by weight of recyclate.

Preferably, a multilayer plastic bottle or preform according to an embodiment of the invention comprises at most 98% by weight of recyclate. More preferably, the content of recyclate is at most 95, 90, 85, 80, 75, 70, 65, 60, 55, 50% by weight of recyclate.

Preferably, a multilayer plastic bottle or preform according to an embodiment of the invention comprises between 25 and 40% by weight of recyclate, endpoints included, calculated on the total weight of the preform or dairy bottle.

With respect to the present invention, a dairy bottle refers to any bottle suitable for including a sterilized dairy product. The shape can vary from a common dairy bottle to a dairy carton. Smaller packagings such as small drinking bottles and cartons are also not excluded. A dairy bottle according to the invention may comprise any suitable closure ranging from caps to breakable membranes.

Preferably, the outer layer of the dairy bottle comprises polyester material comprising a white pigment, such as titanium dioxide, calcium carbonate or zinc oxide. Preferably, the outer layer comprises titanium dioxide. The polyester material is preferably PET. The incorporation of the white pigment gives the bottle a white appearance.

Preferably, the outer layer comprises between 0.5 and 10% by weight of white pigment. More preferably, the outer layer comprises between 1.0 and 8% by weight of white pigment. Most preferably, the outer layer comprises between 3.0 and 7.0% by weight of white pigment.

Preferably, the middle layer of the dairy bottle comprises polyester material. The polyester material is preferably PET. For adjusting the opacity of the middle layer and of the dairy bottle, dye is preferably added to the middle layer. The use of coal black is preferably excluded. The incorporation of dye gives the middle layer a coloured appearance. Preferably, the middle layer comprises between 0.01 and 10% by weight of dye.

A multilayer dairy bottle according to an embodiment of the invention preferably comprises:
a) an outer layer containing 0.5-7% of titanium dioxide and having a thickness between 30 and 250 micrometers;
b) an opaque middle layer containing 0.01-10% by weight of dye and having a thickness between 50 and 800 micrometers;)
c) an inner layer, for contact with the dairy product, optionally containing 0.5-7% of titanium dioxide and having a thickness between 30 and 250 micrometres.

In a third aspect, the invention provides a multilayer dairy packaging, comprising a multilayer plastic bottle according to a preferred embodiment of the invention and a sterilized dairy product contained in the multilayer plastic bottle; preferably, the sterilized dairy product is milk.

Preferably, the middle layer provides at least 10% of wall thickness.

If necessary, the material for the middle layer is additionally coloured for providing a desired opacity. Preferably, the additional dying is done with a dark dye, excluding carbon (black) which by definition is not a dye.

The middle layer contributes significantly to blocking the light. This is measured by determining the opacity of a bottle or preform at 540 nm. For this purpose, the residual transmission of light is measured with a spectrophotometer according to a standard measuring procedure, such as ASTM D1003, using a D65 lamp simulating natural daylight. The residual transmission at 540 nm is preferably below 4%, more preferably below 2%, and most preferably below or equal to 0.1%.

If residual light transmission is higher than the desired value, additional dye can be added to achieve the required opacity.

Colour determination is done by taking L*a*b* measurements from the CIELAB system using a spectrophotometer. The L* value is a measure of brightness. Here, an L* value of 0 equals to all black and an L* value of 100 equals to all white. The L* value should be more than or equal to 65. The a* and b* values are a measure of colour and should preferably be located between −2 and +2, more preferably between −1.5 and +1.5, and most preferably between −1 and 1.

The plastic bottle is a dairy bottle, more preferably a milk bottle. In the method, a light barrier is incorporated for this purpose. Preferably, the light barrier is incorporated into the middle layer. More preferably, the light barrier is incorporated into a polyester middle layer, most preferably a PET middle layer.

A light barrier for a dairy bottle means essentially sealing the bottle against ultraviolet radiation and visible light, in particular against light with a wavelength shorter than 550 nm. This is advantageous for reducing the degradation of vitamin B2 in dairy products.

Preferably, a dairy bottle is filled with a sterilized dairy product by an aseptic filling method. This is advantageous for avoiding bacterial contamination.

Preferably, the dairy bottle is oxygen-tight. The method therefore comprises incorporating an oxygen barrier, for example by using nylon, polyester, ethyl vinyl alcohol (EVOH) or polyamide.

Preferably, in the middle layer, recyclate is used which is derived from the processing of used plastic beverage bottles or plastic preforms for bottles. This bottle-to-bottle method is advantageous because of its low environmental impact. Sustainable reuse is ensured.

The opaque recyclate can also be part of the inner and/or outer layer. This opaque recyclate may be admixed with the raw material for the production of the inner and/or outer layer, preferably by at least 10% by weight, more preferably up to 20% by weight, most preferably equal to or greater than 20%

The invention is further illustrated by means of examples. These examples are non-limiting.

### Example 1

A fraction of opaque bottles is collected and then sorted by colour. An analysis is performed for separating food and non-food bottles. The purpose of the separation is to remove HDPE plastic bottles used for non-food applications, among other things. The remaining bottles are shredded into chips. The chips go into a flotation bath, in which PET material is separated from polyethylene (PE) and other non-PET materials such as polyolefin caps and labels. The fraction of PET material is then washed. If desired, the chips can still be sorted by colour. The fraction of washed PET material is then extruded into a granulate. If desired, a solid-state step is performed. Hereby, the materials are kept at elevated temperature and reduced pressure. This affects the viscosity of the treated materials. It is also a requirement for the material to be food-grade.

The plastic PET material obtained is incorporated into a dairy bottle. During an injection moulding process, a multilayer preform for a dairy bottle is made. The middle layer includes at least 9% by weight of recycled PET material expressed based on the total weight of the preform. The preform includes 25% by weight of PET recyclate, expressed based on the total weight of the preform.

### Example 2

A multilayer plastic dairy bottle according to an embodiment of the invention comprises, for example, an inner and outer layer that is white-coloured, and a middle layer that provides sufficient light blocking for preservation of a dairy product. The inner and outer layers consist of the same material, preferably PET with a white dye and at least 15% by weight of an opaque PET recyclate, expressed based on the total weight of the multilayer dairy bottle. The middle layer also consists of PET, preferably obtained from opaque PET recyclate and a dark dye. This middle layer has a thickness equivalent to 10% of the bottle wall thickness. This recyclate comes from recycled dairy bottles, preferably recycled milk bottles. This recyclate is already loaded with an opaque dye and provides a certain blocking of incident light. This can be improved by adding a dark dye if desired. The multilayer dairy bottle preferably contains at least 9% by weight, and more preferably 25% by weight or more of recyclate expressed based on the total weight of the dairy bottle.

### Example 3

A multilayer plastic dairy bottle according to an embodiment of the invention comprises, for example, an inner and outer layer that is white-coloured, and a middle layer that provides sufficient light blocking. The inner and outer layers consist of the same material, preferably PET with white dye. The middle layer also consists of PET, preferably opaque PET recyclate. This is achieved by using coloured PET recyclate. This middle layer has a thickness equivalent to at least 10% of the bottle wall. The thickness of the middle layer can be increased in a controlled manner up to 40% of the wall thickness. This coloured recyclate is already loaded with opaque dye and provides a certain blocking of incident light. This can be improved by adding a dark dye if desired.

1-19. (canceled)

20. A method for processing dairy bottle recyclate into a new production of dairy bottles, comprising the steps:
shredding used plastic dairy bottles, followed by mechanical recycling, in which a dairy bottle recyclate in the form of a granulate is obtained,
incorporating the dairy bottle recyclate by injection moulding thereby forming a middle layer in a preform for a new multilayer plastic dairy bottle, the preform after incorporation comprising an inner layer for contact with the contents of the dairy bottle in use, an outer layer located opposite the inner layer and a middle layer located between the inner and outer layer;
in which the inner and outer layers are white and the middle layer is black, grey or coloured; and
in which the middle layer has less than 5% transmission of light measured by a spectrophotometer according to ASTM D1003 at 530 nm, using a D65 lamp simulating natural daylight.

21. The method according to claim 20, wherein the dairy bottle recyclate is coloured.

22. The method according to claim 20, wherein the middle layer has less than 1% transmission of light measured by a spectrophotometer according to ASTM D1003 at 530 nm, using a D65 lamp simulating natural daylight.

23. The method according to claim 20, wherein no recyclate originating from a non-food application is processed in the dairy bottle.

24. The method according to claim 20, wherein the dairy bottle recyclate is a milk bottle recyclate and the new dairy bottles are new milk bottles.

25. The method according to claim 20, wherein the dairy bottle recyclate is a polyester plastic fraction.

26. The method according to claim 20, wherein the preforms are blown thereby forming the new dairy bottles encompassing, in the middle layer, dairy bottle recyclate.

27. The method according to claim 20, comprising the steps:
producing a preform in an injection mould, wherein a predetermined amount of a first material is injected into a mould cavity and a predetermined amount of a second material is injected into this mould cavity to form a core in the injected first material,
wherein, in a main phase, the first material is completely injected into the mould cavity, followed by the second material which is completely injected, in a consecutive injection,
wherein, during the consecutive injection, the first material is injected to provide an inner and an outer side of a preform and the second material is injected into an area at the level of the injection opening of the injection mould to provide a middle layer of a preform located between the inner and outer side of the preform,
in a final phase, the first material will be pushed to the preform mouth by injecting the second material, the second material always being injected into the middle layer without the possibility of breaking through to the inner of outer side of the preform,
wherein, the first material is polyester and the second material is an opaque plastic fraction with exclusion of a black opaque plastic fraction; the second material is an opaque coloured polyester plastic fraction.

28. The method according to claim 20, comprising the steps:
producing a preform in an injection mould, wherein a predetermined amount of a first material is injected into a mould cavity and a predetermined amount of a second material is injected into this mould cavity to form a core in the injected first material,
wherein, during parallel injection, the first material is injected on the inner and outer side and the second material is injected in the middle layer in an area at the level of the injection opening of the injection mould,
wherein, in a preliminary phase, only a predetermined amount of the first material is injected into the injection mould,
wherein, in a final phase, a predetermined amount of the first material is injected, and, as appropriate, the second material is further pushed into a front portion of the injection mould,
wherein the first material is polyester and the second material is an opaque plastic fraction to the exclusion of a black opaque plastic fraction; the second material is an opaque coloured polyester plastic fraction.

29. The method according to claim 20, wherein the material for the middle layer is additionally coloured for increasing the opacity of the middle layer.

30. The method according to claim 20, wherein the middle layer provides at least 5% wall thickness.

31. The method according to claim 20, wherein the dairy bottles of a dairy bottle filler are reworked into new dairy bottles for the same filler (“bottle-to-bottle”).

32. The method according to claim 20, wherein the used dairy bottles from a pre-identified dairy bottle filler are collected separately and processed into new dairy bottles for the pre-identified dairy bottle filler (“closed-loop”).

33. A multilayer plastic bottle for containing and storing dairy product, comprising an inner layer for contact with the contents of the bottle or preform, an outer layer located opposite the inner layer and a middle layer located between the outer and the inner layer,
wherein the middle layer comprises an opaque plastic fraction, the middle layer is black, grey or coloured;
wherein the multilayer dairy plastic bottle is obtainable with a method according to claim 20; and
wherein the middle layer has less than 5% transmission of light measured by a spectrophotometer according to ASTM D1003 at 530 nm, using a D65 lamp simulating natural daylight.

34. The multilayer plastic bottle according to claim 33, wherein the middle layer provides at least 5% wall thickness.

35. The multilayer plastic bottle according to claim 33, wherein the middle layer comprises at least 25% by weight of recyclate calculated based on the total weight of the preform or dairy bottle.

36. The multilayer plastic bottle according to claim 33, wherein the outer and inner layers are white-coloured.

37. The multilayer plastic bottle according to claim 33, wherein the middle layer comprises PET recyclate.

38. A multilayer dairy packaging, comprising a multilayer plastic bottle according to claim 33 and a sterilized dairy product contained in the multilayer plastic bottle.
